(19) United States
(12) Patent Application Publication
(10) Pub. No.: US 2025/0047465 A1
(43) Pub. Date: Feb. 6, 2025

(54) SYSTEMS AND METHODS FOR ENHANCED DIGITAL SIGNATURE SCHEMES

(71) Applicant: CABLE TELEVISION LABORATORIES, INC., Louisville, CO (US)

(72) Inventor: KYLIE SCHNOOR, Broomfield, CO (US)

(21) Appl. No.: 18/794,956

(22) Filed: Aug. 5, 2024

Related U.S. Application Data
(60) Provisional application No. 63/530,633, filed on Aug. 3, 2023.

(51) Int. Cl. H04L 9/06; H04L 9/08; H04L 9/32

(52) U.S. Cl. CPC H04L 9/0618; H04L 9/0869; H04L 9/3263

(57) ABSTRACT

A system for processing digital signatures includes a sender device and a receiver device. The sender device encrypts a plaintext message and transmits an encrypted ciphertext message to the receiver device. The receiver device receives and decrypts the encrypted ciphertext message into a coded plaintext message, which is then decoded to output a readable plaintext message to the receiver device substantially corresponding to the plaintext message at the sender device. The sender and receiver devices are in communication with a certificate authority of a public key infrastructure configured to generate a keypair including a public key and a private key. The sender encrypts the plaintext message, and the receiver device decrypts the encrypted ciphertext message, using a common coding scheme that is configured for a document containing the public key.

### CROSS REFERENCE TO RELATED APPLICATIONS

This application claims the benefit of and priority to U.S. Provisional Patent Application No. 63/530,633, filed Aug. 3, 2023, the entire content and disclosure of which is incorporated by reference herein in its entirety.

### BACKGROUND

The field of the disclosure relates generally to network communications, and more particularly, to systems and methods for digital signature cryptography.

As computing power and the rise of quantum computing continually increase threats to cybersecurity, the need for post-quantum alternatives similarly increases. More particularly, the need for post-quantum techniques and algorithms has infiltrated every aspect of cryptography and digital security, including the use of digital signatures within a public key infrastructure (PKI). PKI is designed to ensure the identity of users and their respective cryptographic keys, for example, through both the issuance of certificates and the digital signing thereof for verification.

In a PKI network, system, or ecosystem, a certification authority (CA) issues a digital certificate to a user electronic device. The digital certificate identifies the user/user device, while also providing information relating to cryptographic capabilities of the user device. Typically, to ensure that the certificate was issued in good faith and that is has not been tampered with, the CA will digitally sign a digital certificate, which is validated using the CA public key in the CA certificate, which is issued by a higher level of CA (e.g., a root CA). An outside party may then utilize a verification algorithm to check the signature of the certificate using the CA public key.

Conventionally, a given PKI may not utilize only a single CA for issuing digital certificates; often, a chain of CAs may be utilized to increase security, e.g., such as where a CA “higher up” in the chain signs certificates for a CA “lower” in the chain. In this scenario, one CA in the chain is designated the “root CA,” meaning that there are no CA higher up in the chain. The root CA establishes the root of trust for the chain, and it is therefore essential that the root CA cannot be compromised, since the root CA signs its root CA certificate as the trusted authority.

Conventional digital signature schemes are typically based on algorithms that may utilize one or more of (a) integer factorization, such as the Rivest-Shamir-Adleman (RSA) public key cryptosystem, (b) the discrete-logarithm problem, such as according to the Elliptic Curve Diffie-Hellmann+(ECDH) key agreement protocol, and/or (c) National Institute of Standards and Technology (NIST)-defined standards for rising post-quantum alternatives, such as the lattice-based CRYSTALS-Dilithium method and Falcon method. Conventional signature schemes have been widely implemented with PKI for being considered “balanced,” i.e., the size (e.g., number of bytes) of the relevant public and private keys is comparable to the size of the signature. However, as the security needs of the root CA continues to increase, the relative size of the root CA public and private keys has also increased. Consequently, many conventional devices (e.g., smartphones, tablets, laptops, etc.) do not have the power and/or resources to adequately process digital signatures and public/private keys of increasing size.

Accordingly, there is a need in the industry for improved digital signature schemes within the PKI paradigm that increase security, but without a proportionate increase in the processing resources required for digital signature generation and verification.

### SUMMARY

In an embodiment, a system is provided for processing digital signatures. The system includes a sender device and a receiver device. The sender device is configured to encrypt an original plaintext message into an encrypted ciphertext message and transmit the encrypted ciphertext message over a communication medium in operable communication with the sender device. The receiver device is also in operable communication with the communication medium, and is configured to receive the encrypted ciphertext message from the communication medium, decrypt the encrypted ciphertext message into a coded plaintext message, decode the coded plaintext message into a readable plaintext message, and output the readable plaintext message to the receiver device such that the readable plaintext message substantially corresponds to the original plaintext message at the sender device. Each of the of the sender device and receiver device are also in operable communication with a certificate authority (CA) of a public key infrastructure (PKI) configured to generate at least one keypair including a public key and a private key. The sender device is further configured to encrypt the original plaintext message, and the receiver device is further configured to decrypt the encrypted ciphertext message, using a coding scheme common to both of the sender and receiver devices. The common coding scheme is further configured for at least one document containing the public key.

In an embodiment, an apparatus is provided for signing a digital certificate from a Certificate Authority (CA) of a Public Key Infrastructure (PKI). The apparatus includes a processor and a memory device in operable communication with the processor. The memory device is configured to store computer-executable instructions therein, which, when executed by the processor, cause the apparatus to (a) obtain a PKI certificate from the CA, and (b) concatenate a hash of the PKI certificate with a first number of bits of a random n-bit vector, n being an integer greater than 2, (c) compute a syndrome for the concatenated hash of the PKI certificate, (d) calculate a codeword based on (i) the computed syndrome, (ii) a public key of the PKI certificate, and (iii) the concatenated hash of the PKI certificate, (e) decode the codeword to obtain a signature element therefrom, and (f) output a digital signature for the PKI certificate based on (i) the signature element, (ii) the random n-bit vector, and (iii) the computed syndrome.

In an embodiment, an apparatus is provided for verifying a signature for a Public Key Infrastructure (PKI) certificate. The apparatus includes a processor and a memory device in operable communication with the processor. The memory device is configured to store computer-executable instructions therein, which, when executed by the processor, cause the apparatus to (a) obtain a signature of the PKI certificate, and (b) concatenate a hash of the PKI certificate with a first number of bits of a random n-bit vector, n being an integer greater than 2, (c) calculate a first codeword based on a signature element of the obtained signature and a public key of the PKI certificate, (d) compute (i) a first verification vector based on the random n-bit vector and the public key of the PKI certificate, and (ii) a second verification vector based on the concatenated hash of the PKI certificate, (e) calculate a second codeword based on (i) the first verification vector and (ii) the concatenated hash of the PKI certificate, (f) compare the first codeword with the second codeword, and (g) verify, based on the comparison of the first codeword with the second codeword, the obtained signature for the PKI certificate.

### BRIEF DESCRIPTION OF THE DRAWINGS

These and other features, aspects, and advantages of the present disclosure will become better understood when the following detailed description is read with reference to the following accompanying drawings, in which like characters represent like parts throughout the drawings.

FIG. 1 is a schematic illustration of a communication system utilizing a public key infrastructure, according to an embodiment.

FIG. 2 is a flow diagram depicting an exemplary digital signing process for the sender device and/or the encryption module depicted in FIG. 1.

FIG. 3 is a flow diagram depicting an exemplary digital verification process for the receiver device and/or the decryption module depicted in FIG. 1.

FIG. 4 is a graphical illustration depicting exemplary matrices generated according to the embodiments herein.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the term “database” may refer to either a body of data, a relational database management system (RDBMS), or to both, and may include a collection of data including hierarchical databases, relational databases, flat file databases, object-relational databases, object oriented databases, and/or another structured collection of records or data that is stored in a computer system.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include any computer program storage in memory for execution by personal computers, workstations, clients, servers, and respective processing elements thereof.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment.

In the embodiments described herein, these activities and events occur substantially instantaneously.

As used further herein, “CA” may refer to a certificate authority hosting a root certificate, and may further include, without limitation, one or more of a CA computer system, a CA server, a CA webpage, and a CA web service.

As used herein, “Public Key Infrastructure” (PKI) refers to an electronic device or system that uses a pair of cryptographic keys (e.g., one public and one private) to encrypt and decrypt data. PKI utilization enables, for example, devices to obtain and renew X.509 certificates, which are used to establish trust between devices and encrypt communications using such protocols as Transport Layer Security (TLS), etc. A PKI includes policies and procedures for encrypting public keys, as well as the creation, management, distribution, usage, storage, and revocation of digital certificates. The PKI binds the public keys to the identity of a person or legal entity, typically through a trusted Certificate Authority (CA). The PKI hierarchy identifies a chain of trust for a device or program, and further may provide secure software download requirements for the devices, and/or secure certificate injection requirements on the device manufacturers. The CA, the electronic devices, the device manufacturers, and users of the device interact over a PKI ecosystem.

As used herein, a message or certificate that is protected with a digital signature is referred to herein as being “digitally signed.”

The present systems and methods provide an improved signature scheme for PKI-protected communications and/or certificates. In an exemplary embodiment, an enhance-McEliece digital signature scheme is provided. The present enhanced-McEliece scheme is based in part on the McEliece cryptosystem, which is a post-quantum cryptosystem based on algebraic coding theory; however, conventional McEliece-based schemes merely provided key exchange mechanisms or algorithms, but were not used within the PKI paradigm. Conventional schemes based on the McEliece cryptosystem are thus unable to offer the level of security needed for implementation within a PKI. Moreover, as explained in greater detail below, these conventional schemes are known to be too taxing on the storage capacity of typical digital certificates.

The present systems and methods overcome these challenges through implementation of an enhanced-McEliece digital signature scheme that is of particular value with respect to a root CA of a PKJ. According to the embodiments herein, an innovative signature scheme is provided that leverages the security stability of the McEliece cryptosystem, but without proportionally increasing the commensurate processing requirements of respective devices or significantly increasing the storage capacity of the digital certificates exchanged thereby.

In an exemplary embodiment, new and improved techniques are provided for generating and verifying digital signatures for PKI digital keypairs generated from a respective CA. In some embodiments, the present digital signature and verification techniques are implemented by dedicated hardware devices or modules in communication or integrated with existing communication devices. In other embodiments, digital signatures are generated and verified using particular algorithms programmed into the respective memories of electronic devices, and then executed by a processor of the respective device that is in communication with its associated memory. In at least one embodiment, the present digital signature and verification techniques may be executed through a combination of respective hardware and software modules.

### Coding Theory and Goppa Codes

Coding theory is based on how to correct a message that has been corrupted by noise. Conventional encoding schemes typically involve inputting a message of a specific length, and then outputting a codeword with error correcting capabilities. The conventional McEliece cryptosystem has been implemented based on the difficulty of decoding a corrupted codeword (i.e., a codeword with error) without knowing the specifics of the underlying code used. Generally, the conventional McEliece cryptosystem employs a binary Goppa code, which is constructed to denote a polynomial g(x), of t, over a Galois field, GF(2^{m}), where both t and m represent parameters that define the Goppa code. Goppa codes are a specific type of linear error-correcting code that are used in cryptography, particularly in the context of the McEliece cryptosystem.

For the Goppa code, g(x) is typically restricted to be irreducible and separable (i.e., no repeated roots). For example, for a given subset L={α₁, α₂, α₃, . . . αₙ}, where αᵢ∈GF(2^{m}) and g(αᵢ)≠0, L represents a subset of field elements that are not roots of g(x). Another defining parameter of the Goppa code may be the length n of the subset L. Accordingly, the Goppa code may be represented as Γ(L, g(x)). The Goppa code thus includes all of the vectors (i.e., codewords), c=(c₁, c₂, . . . , cₙ) over GF(2^{m}), such that the following equation is satisfied:

$${R}_{c} ( x ) = {\sum }_{i = 1}^{n} \frac{{c}_{i}}{x - {α}_{i}} ≡ 0 mod g ( x ) \qquad ( Eq . 1 )$$

It may be seen, from Eq. 1, that R_{c}(x) is a multiple of g(x). Additionally, there may be multiple Goppa codes for a given set of parameters. For example, while the degree of g(x) is restricted by such parameters, there are often many irreducible polynomials of a certain degree over the given field. Therefore, since there are many choices available within the given set of parameters, it is easier to ensure that the desired Goppa code is only known by the key-generating party. As described above, the parameters t (i.e., how many errors can be corrected by the Goppa code), m, and n (i.e., the length of the codeword(s)) further influence the dimension of the code.

### The McEliece Cryptosystem

The McEliece cryptosystem is a code-based cryptosystem that relies on adding intentional error to a permuted codeword in order to encrypt messages. The parameters of the McEliece cryptosystem are based on an underlying code. The McEliece cryptosystem typically employs an (n−k)-Goppa code having an error correcting capability of t-bits. For this particular Goppa code, the McEliece cryptosystem will require a: (1) k×k matrix S; (2) k×n matrix G; and (3) n×n matrix P.

Accordingly, implementation of the McEliece cryptosystem may generate a public key, pk, from the product of these three matrices according to the following equation:

$$p k = {G}^{′} = SGP . \qquad ( Eq . 2 )$$

Additionally, using the McEliece cryptosystem a private key, or secret key, sk, may be generated for each such individual matrix according to the following equation:

$$s k = ( S , G , P ) . \qquad ( Eq . 3 )$$

Using these generated public and private keys, conventional encryption and decryption algorithms have been implemented as a series of matrix multiplication and decoding. For example, a message sending device may begin with a plaintext vector x of length k, and then encode the plaintext vector x using the public key, pk, such that an encoded vector conforms to the following equation:

$${y}_{0} = x S G P . \qquad ( Eq . 4 )$$

After encoding the plaintext vector, intentional error e may be added to the respective codewords. Generally, the added intentional error may not exceed the error correcting capability of the code. That is, the weight of the error e should be, at most, t. A ciphertext/codeword, c, may then be obtained by adding the error e to the encoded vector as follows:

$$c = x S G P + e \qquad ( Eq . 5 )$$

The ciphertext c is then sent to a message receiving device capable of decrypting the received communication using the private/secret key sk. Because the receiving device has access to the secret key sk, the receiver may decrypt the received communication by multiplication with a permutation matrix, P⁻¹, to yield:

$$c {P}^{- 1} = ( x S G P + e ) {P}^{- 1} \qquad ( Eq . 6 )$$

$$= xSG + e {P}^{- 1} \qquad ( Eq . 7 )$$

Since P⁻¹ is a permutation matrix, multiplication thereby will not change the weight of the error e. Since the error e has weight of at most t, the result of eP⁻¹ will also have a weight of no more than t, based on the well-understood principle that ciphertext cannot have a larger weight than the error correcting capabilities of the code, or else the decryption process will not be successful.

Furthermore, in addition to considering the vector x as the word subject to decoding, the preceding equations further allow a scrambled word, xS, to be the subject of decoding. For example, using the decoding algorithm associated with the Goppa code, the scrambled message xS may similarly be obtained by decoding cP⁻¹, and the original message x may then be recovered through multiplication by S⁻¹.

### The MGD Scheme

One proposed conventional digital signature scheme is known as the Makoui-Gulliver-Dakhilalian scheme, also referred to as the “MGD scheme.” The MGD scheme is based on the McEliece cryptosystem, but has created many new challenges regarding its implementation. For example, whereas the MGD scheme allows for shorter signatures (e.g., fewer memory bytes in a digital certificate), these shorter signatures have conventionally reduced the overall security afforded by the MGD scheme.

More particularly, the MGD scheme builds off of the McEliece cryptosystem through the utilization of several matrices: (a) G, a generator matrix of the Goppa code; (b) H, a parity-check matrix of the Goppa Code; (c) H⁻¹, a pseudo-inverse of the Goppa code; (d) P, a permutation matrix; and (e) L and S, which represent random and non-singular (i.e., invertible) matrices, respectively. Using these matrices, the MGD scheme may construct the public key, pk, according to:

$$p k = ( {p}_{1} , {p}_{2} , {p}_{3} ) , \qquad ( Eq . 8 )$$

$$where :$$

$${p}_{1} = SGP ; \qquad ( Eq . 9 )$$

$${p}_{2} = {{L}^{- 1} ( {H}^{- 1} )}^{T} P ; and \qquad ( Eq . 10 )$$

$${p}_{3} = {{P}^{- 1} ( {H}^{- I} H )}^{T} P , \qquad ( Eq . 11 )$$

and generate a private key, pr, according to:

$$p r = ( {S}^{- 1} , {P}^{- 1} , Q , G ) , \qquad ( Eq . 12 )$$

$$where$$

$$Q = {( {L}^{T} H ( {P}^{- 1} ) )}^{T} . \qquad ( Eq . 13 )$$

A signature algorithm is then created using such generated keypairs from the MGD scheme. The MGD scheme signature algorithm first uses a hash function to twice hash the relevant document to create h(doc) and h(h(doc)), respectively. That is, the MGD scheme requires that the hash document return the hash to a length of n bits, which is necessary for the MGD scheme, since the h(doc) element is directly used to create a codeword according to the following computed vectors:

$$s = h ( d o c ) Q ; and \qquad ( Eq . 14 )$$

$$sigSGP = h ( d o c ) + s {p}_{2} . \qquad ( Eq . 15 )$$

From the computed vector of Eq. 15, sigSGP is first multiplied on the right by P⁻¹, and then decoded using a decoding algorithm for the Goppa code to obtain the value sig. Lastly, the h(h(doc)) element is used to compute the value for d according to the following equation:

$$d = h ( h ( d o c ) ) Q + s . \qquad ( Eq . 16 )$$

The digital signature of the relevant document is then represented according to σ=(sig, d), which includes both the digital signature and the document itself. According to the MGD scheme, the digital signature will have a length of π bits.

The MGD scheme further proposes a verification algorithm to verify whether a given signature is correct. This MGD scheme verification algorithm begins with receiving the signature and using the same hash functions from the digital signature to recompute the h(doc) and h(h(doc)) elements. The verifying device then computes the following vectors from the signature and public key:

$$a = s i g {p}_{1} ; \qquad ( Eq . 17 )$$

$${v}_{1} = h ( h ( d o c ) ) {p}_{3} + d {p}_{2} ; and \qquad ( Eq . 18 )$$

$${v}_{2} = h ( d o c ) {p}_{3} . \qquad ( Eq . 19 )$$

According to the MGD scheme, a first verification attempt checks whether vectors v₁=v₂. If these two vector values are not equal, then the verification attempt fails. If the vectors are equal, the verification process of the MGD scheme verification algorithm makes a second verification attempt by computing:

$$c = h ( d o c ) + s {p}_{2} . \qquad ( Eq . 20 )$$

The verifying device of the MGD scheme then checks whether vectors a=c. If these two vector values are equal, then verification according to the MGD scheme is considered to be complete. Otherwise, the verification fails.

This conventional MDG scheme, however, has significant shortcomings that have prevented the MGD scheme from heretofore being successfully implemented within the PKI paradigm. One such shortcoming arises from the MGD scheme requirement that the hashed document must return an n-bit hash, or the length of a codeword. This requirement is problematic for PKI since the most widely-used conventional hash algorithms are known to return relatively short hashes (e.g., 256 or 512 bits). The use of such shorter-length hashes to create codewords does not provide a sufficient level of security for use in a signature algorithm for a PKI. That is, the shorter a codeword is, the more susceptible will be the corresponding McEliece cryptosystem to an attack (e.g., the chance to randomly guess a correct matrix will be significantly lowered). For comparison, the proposed NIST parameters of the McEliece cryptosystem begin with codewords having lengths of at least 3488 bits, and then only for the lowest levels of security.

In other words, the proposed security level will increase as the length of the codeword increases as well. Given the need for long-lasting certificates in a PKI, there is a desire in the industry for codewords having significantly greater lengths than those provided according to the MGD scheme.

Another shortcoming of the MGD scheme is also related to its use of hash functions. Hash functions are known to be computationally slow, relative to other computational processing, and the MGD scheme employs two different hash functions in its signature and verification algorithms, thereby rendering the MGD scheme further impractical for implementation with a PKI, since the PKI paradigm continually seeks to reduce the computational speed and processing resources for digital signatures and verification.

The MGD scheme presents yet another shortcoming arising from its proposal to adjust its signature algorithm to sign a document multiple times. This proposed signature algorithm adjustment, however, is unnecessarily burdensome within the PKI paradigm, in light of the particular longevity of PKI certificates.

The following embodiments thus represent significant improvements over the conventional digital signature schemes, described above, based on conventional implementations of Goppa codes, the McEliece cryptosystem, and the MGD scheme. In an exemplary embodiment, the present systems and methods modify these conventional techniques with respect to the PKI paradigm to successfully overcome the conventional shortcoming through enhanced digital signature and verification modules and algorithms.

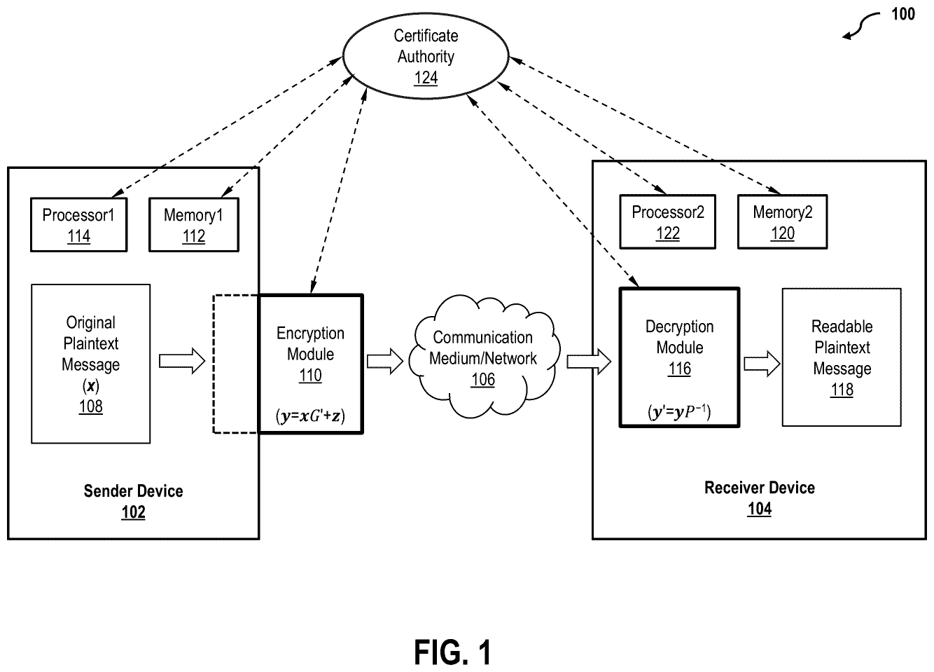

The embodiments herein thus provide innovative systems and methods that leverage advantageous properties of several conventional techniques, while avoiding their known shortcomings, described above. As described further herein, the present systems and methods are referred to as enhanced digital signature and/or verification schemes, algorithms, systems, and/or apparatuses for use with PKI. An exemplary scenario for implementing these enhanced digital signature and verification schemes is described further below with respect to FIG. 1.

FIG. 1 is a schematic illustration of a communication system 100 utilizing a PKI (not separately shown). In the exemplary embodiment depicted in FIG. 1, communication system 100 includes a sender device 102 (e.g., smartphone, PDA, tablet, laptop or desktop computer, transceiver, etc.) in communication with a receiver device 104 (e.g., smartphone, PDA, tablet, laptop or desktop computer, transceiver, etc.) over a communication medium (e.g., LAN, WLAN, Wi-Fi, cellular network, the Internet, free space optics (FSO), etc.).

In exemplary operation of communication system 100, sender device 102 obtains or generates an original plaintext message 108. For this example, plaintext message 108 may be represented as a vector, and may be broken into blocks of a desired length prior to sending. The person of ordinary skill in the art will understand that the exemplary scenarios herein are provided by way of illustration, and are not intended to be limiting. Sender device 102 then provides original plaintext message 108 to an encryption module 110. In some embodiments, encryption module 110 is disposed remotely from sender device 102. In other embodiments, encryption module 110 is co-located and/or integrated with sender device 102. In at least one embodiment, encryption module 110 may be configured as computer-executable instructions stored in a sender memory 112 of sender device 102, which instructions may then be executed by a sender processor 114 in communication with sender memory 112.

In further exemplary operation, encryption module 110 encrypts original plaintext message 108 into ciphertext. In an exemplary embodiment, encryption module 110 may be configured to encrypt a plaintext message x (e.g., original plaintext message 108) into ciphertext message y, such that y=xG′+z. Encryption module 110 may then be further configured to send the ciphertext message y to receiver device 104 over communication medium 106.

At the receiver side, receiver device 104 includes a decryption module 116 configured to receive the ciphertext message y, and then decrypt the ciphertext message y into plaintext, for example, using a decoding algorithm specific to the particular Goppa code. In an exemplary embodiment, decryption module 116 multiplies ciphertext message y by permutation matrix P⁻¹ to yield a decrypted plaintext message y′ according to:

$${y}^{′} = y {P}^{- 1} , \qquad ( Eq . 21 )$$

which may be further broken down as:

$${y}^{′} = ( x {G}^{′} + z ) {P}^{- 1} ; \qquad ( Eq . 22 )$$

$${y}^{′} = x {G}^{′} {P}^{- 1} + z {P}^{- 1} ; and \qquad ( Eq . 23 )$$

$${y}^{′} = ( x S ) G + z {P}^{- 1} \qquad ( Eq . 24 )$$

where zP⁻¹ denotes a permuted error. From Eq. 24, it may be seen that the decoding functionality of decryption module 116 is enabled to treat the scrambled word xS as the “message” to be decoded, and the original message x may thus be recovered from plaintext message y′ through multiplication by S⁻¹. In this manner, a readable plaintext message 118, which corresponds to original plaintext message 108, is generated at receiver device 104.

In the examples described above and further herein, bolded text generally indicates vectors, and italic text generally denotes either a matrix or a parameter, variable, and/or element understood by the person of ordinary skill in the art from the context of the particular equation.

In the exemplary embodiment depicted in FIG. 1, decryption module 116 is illustrated as an integral portion of receiver device 104. In some embodiments, decryption module 116 may be a distinct dedicated hardware element. In other embodiments, decryption module 116 may be configured as computer-executable instructions stored in a receiver memory 120 of receiver device 104, which instructions may then be executed by a receiver processor 122 in communication with receiver memory 120.

The enhanced signature scheme of communication system 100 further differs from conventional techniques with respect to the capability of obtaining relevant keys, used by sender device 102 and receiver device 104, from a CA 124 in communication with both of sender device 102 and receiver device 104. CA 124 may additionally be in operable communication with one or more of encryption module 110, sender memory 112, sender processor 114, decryption module 116, receiver memory 120, and receiver processor 122. CA 124, for example, may represent a single CA, or alternatively, may represent a CA chain having a root CA at the “top” of the chain.

According to the exemplary embodiment depicted in FIG. 1, an enhanced signature scheme according to communication system 100 may be considered, at a high level, to include three primary functional portions: (1) key generation; (2) signature; and (3) verification. In an exemplary embodiment, key generation is generally performed by CA 124, signature functionality is generally performed at the sender side (e.g., by sender device 102 and/or encryption module 110), and verification is generally performed by receiver device 104 (e.g., by decryption module 116).

For the exemplary enhanced signature scheme embodiments described herein, C(n,k) is considered to denote a Goppa code of choice, and for given parameters n and k. That is, the length of the codeword is denoted as n, and k denotes a dimension of the code C(n,k) that is dependent on the length n. The person of ordinary skill in the art will understand that although the choice of some code parameters (e.g., longer length, minimal polynomial, etc.) has some flexibility, the length n of the codewords should be at least 3488 bits within the context of the PKI paradigm.

In an embodiment, it may be presumed that one or more of the following matrix and vector elements may be obtained or generated prior to, or as part of, key generation: (a) a (k×n) generator matrix G; (b) an ((n−k)×n) parity check matrix H; (c) invertible (i.e., non-singular) matrices, including (i) a (k×k) matrix S, and (ii) an ((n−k)×(n−k)) matrix L; (d) an (n×n) permutation matrix P; (e) a one-sided inverse H⁻¹ of the parity check matrix H (e.g., including HH⁻¹=I); and (f) a random vector r having a length of n-bits. Nevertheless, these particular matrices may be functionally confined for use with respect to the creation of a public key (e.g., by CA 124, sender device 102) and/or the signature functionality/algorithm executed by sender device 102.

According to the advantageous techniques of the present enhanced signature scheme, there is no need to store these particular matrices with respect to the private key. For example, since L is a random, invertible matrix, no information about the private key can be revealed to an attacker knowing the constitution of the matrix L. Similarly, even if an attacker knew the inverse matrix H⁻¹, the attacker would not be able to discover the parity check matrix H because one portion of the inverse matrix H⁻¹ is random, whereas another part is based on the generator matrix G. Accordingly, even if an attacker knew the generator matrix G, there would still be only a

$$\frac{1}{{2}^{k ( n - k )}}$$

chance that an attacker could choose the correct inverse matrix H⁻¹. Nevertheless, the chance of a successful attack is greatly reduced by keeping the generator matrix G unknown.

### Key Generation

Although the key generation functional portion of the present enhanced signature scheme may be primarily executed with respect to a CA (e.g., CA 124), in an exemplary embodiment, key generation may be performed in cooperation with the signature functional portion of the enhanced signature scheme, e.g., much of which may be executed at the sender/encryption side (e.g., sender device 102, encryption module 110).

As described above, a series of matrices may be generated prior to formation of the relevant public and private keys. The matrices used for the present enhanced signature scheme are summarized below with respect to TABLE 1.

TABLE 1

| Name | Size | Description |
|---|---|---|
| G | k × n | Generator for C(n, k) |
| H | (n − k) × n | Parity-check for C(n, k) |
| H⁻¹ | n × (n − k) | Right-handed inverse for H |
| P | n × n | Permutation matrix |
| S | k × k | Random and non-singular |
| J | (n − k) × (n − k) | Random and non-singular |

In an embodiment, the inverse matrix H⁻¹ may be constructed in a manner similar to the technique employed by the conventional MGD scheme. In the case where the parity check matrix H is standardized to H=[A^{T}|ₙ₋ₖ], where A is obtained from a standardized generator matrix G, then the inverse matrix H⁻¹ may be in the form of:

$${H}^{- 1} = [ \begin{matrix}{B}_{1} \\ {B}_{2}\end{matrix} ] , \qquad ( Eq . 25 )$$

where B₁ is randomized, and where B₂=A^{T}B₁+I_{n_k}.

A random vector r of length n may also be generated separately from, but in addition to, the matrices shown in TABLE 1. In an exemplary embodiment, the vector r is unique for each certificate signed, and should also be accessible by both the signer (e.g., CA 124 for PKI certificates and/or sender device 102 for encrypted messages) and the verifier (e.g., receiver device 104).

However, in the case of PKI, due to the relatively low number of certificates that a root CA (e.g., CA 124) would be signing, it may not be needed to include the random vector r as part of the signature, nor would it be needed to store each vector r as part of the public key. Instead, the enhanced signature scheme of the present embodiments enables generation of the vector r from a pseudorandom generator using a random seed. In this manner, the present systems and methods may advantageously transmit the seed as part of the signature, as opposed to transmitting the entire vector r, thereby representing a significantly more efficient use of computing resources and storage capacity when compared with conventional techniques. That is, because storage of only the seed utilizes significantly less memory than storage of the entire vector r, use of the seed instead of the entire vector enables the signature and verification algorithms to be executed with much greater computational speed.

In addition to these significant improvements to memory utilization, computational speed, and computing resource efficiency, the present systems and methods still further optimize the capability for the parties to flexibly optimize the size of the signature. In an exemplary embodiment, the signing and verifying devices will both have access to the seed and the pseudorandom generator, thereby enabling both the signer and the verifier to be able to generate the entire random vector r as desired, for both the signature process and the verification process, and without needing to store or transmit the actual vector r between sender and receiver.

In this example, it may be noted that the pseudorandom number generator need not output a vector. Instead, a hash output or digest from the pseudorandom number may be in the form of a string of letters and/or numbers denoting a n-bit value. According to the present embodiments, this string of letters and/or numbers may then be readily converted into corresponding binary values, which in turn may then be further used as a vector in the present enhanced signature scheme. Thus, even though the actual creation/generation of the random vector r may occur within the signature and verification portions (e.g., from the seed) of the present enhanced signature scheme, both the pseudorandom number generator and the seed value should be agreed upon beforehand, given that both the signing device and the verifying device will need access to both for correct signing and verification processes.

The implementation of the random vector r for the present enhanced signature scheme represents a significant improvement over the conventional MGD scheme, since the addition of this vector significantly increases the security aspects of the enhanced signature scheme, while still allowing for flexible changes to the vector parameters, such as the length parameter n. Additionally, by implementing the pseudorandom number generator to enable either or both of the sender and receiver to locally generate the vector r from the significantly smaller seed, the present systems and methods greatly mitigate the need for additional storage for signatures of increasing size, while also mitigating the need for larger computing resources being devoted to the transmission, encoding, and decoding of messages and certificates that might otherwise include the entire vector r in the signature.

Nevertheless, the enhanced signature scheme of the present systems and methods still represents a significant improvement over the conventional schemes, described above, even if the entire vector r to either of, or between, the sending and the receiving devices (e.g., sender device 102 and receiver device 104, respectively). For example, depending on the overall goal(s) of the particular PKI, the vector r may be included as part of the public key in some embodiments or, in other embodiments, the vector r may be sent as part of the signature/signing process.

In an embodiment, the determination of whether and/or where to include the vector r may be based on the expected number of certificates that will be signed (e.g., by CA 124 of the PKI). As described above, it is important that the vector r be unique for each certificate signed. Accordingly, in the case where the number of certificates to be signed is low, it may be considered more desirable that the vector r is used as part of the public key (i.e., given that each vector r would be expected to then be stored by the signer device (e.g., in sender memory 112). In other cases, the vector r may become part of the signature itself.

### Public Key

Using the matrices shown above in TABLE 1, a public key may be generated. More particularly the public key, pk=(p₁, p₂, p₃), may be constructed from three public key components p₁, p₂, p₃, which in turn may be constructed according to the following respective matrix multiplications:

$${p}_{1} = SGP ; \qquad ( Eq . 26 )$$

$${p}_{2} = {{J}^{- 1} ( {H}^{- 1} )}^{T} P ; and \qquad ( Eq . 27 )$$

$${p}_{3} = {{P}^{- 1} ( {H}^{- 1} H )}^{T} P . \qquad ( Eq . 28 )$$

Generally, this generation of the public key pk, along with the entire key generation process, may be executed, or at least enabled by, the respective root CA of the PKI (e.g., CA 124).

### Private Key

Different from the public key(s) of the present enhanced signature scheme, the corresponding private key sk or pr may be generated in a manner similar, in many aspects the private key generation techniques provided by the McEliece cryptosystem. That is, the present enhanced signature scheme may similarly encompass the generator matrix G of the Goppa code, as well as the individual matrices S and P. However, different from the McEliece cryptosystem, for the present enhanced embodiments, only the inverses of these respective matrices will be stored, given the importance to be able to use both inverse matrices S⁻¹ and P⁻¹.

Additionally, upon or prior to generation of the public/private keypair, the parity-check matrix H for the scrambled code should also be considered for computing the matrix Q according to the equation:

$$Q = {P}^{- 1} {H}^{T} J . \qquad ( Eq . 29 )$$

Accordingly, after the matrix Q is constructed from Eq. 29, the private key pr takes the form of pr=(S⁻¹, P⁻¹, G, Q). Except where otherwise noted, most, if not all, of the Key Generation processes and algorithms for the present enhanced signature scheme are executed by, or in direct conjunction with, CA 124.

### Signature Algorithm

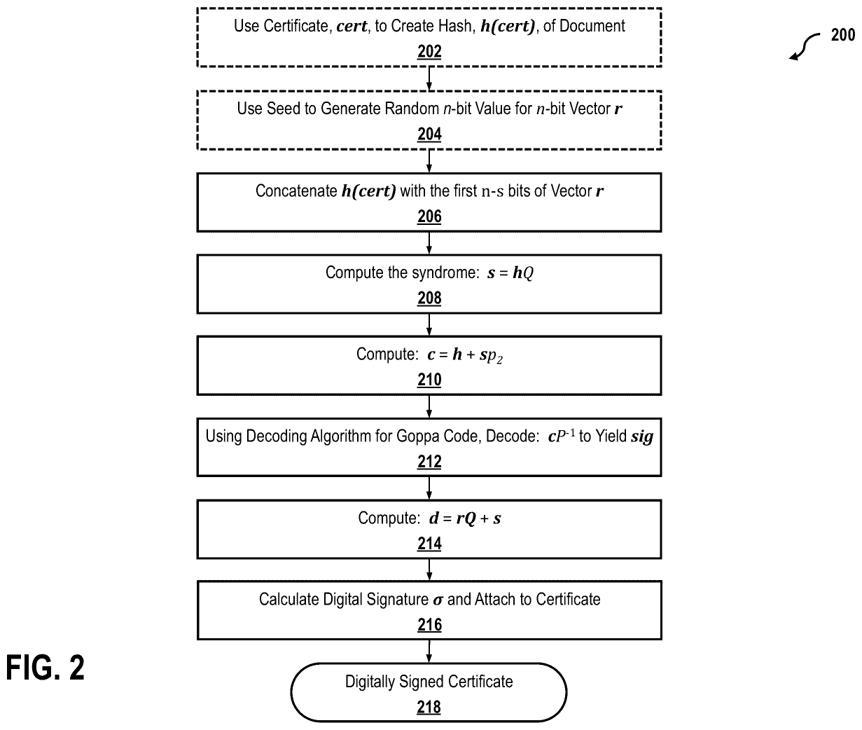

The signature functional portion of the present enhanced signature scheme is described further below with respect to FIG. 2.

FIG. 2 is a flow diagram depicting an exemplary digital signing process 200 for sender device 102 and/or encryption module 110, FIG. 1. In an exemplary embodiment, digital signing process 200 may be executed in cooperation with CA 124, FIG. 1, as well as with one or more of the processing steps described above with respect to the key generation functional portion of the present enhanced signature scheme.

In some embodiments, several steps or substeps of digital signing process 200 may be optional, and/or may be optionally executed separately from digital signing process 200, for example, as preliminary steps thereof, or as a functional steps executed with respect to key generation, as described above. Furthermore, unless described otherwise to the contrary, some steps of digital signing process 200 may be performed in a different order than that described below, and/or one or more steps of digital signing process 200 may be performed simultaneously. Additionally, digital signing process 200 may include more or fewer steps without departing from the scope herein.

With respect to the following detailed description of digital signing process 200, it is assumed that the signer (e.g., CA 124, sender device 102, FIG. 1) will have access to a subject document to be signed. In the exemplary embodiment described with respect to a FIG. 2, the subject document is described to be a certificate, cert, by way of illustration, and not in a limiting sense. That is, digital signing process 200 is described with respect to the PKI paradigm; however, the person of ordinary skill in the art will understand that the advantageous techniques described with respect to digital signing process 200 are not limited solely to PKI implementations. Accordingly, further to this example, it is also assumed that the signer has access to a public key, pk=(P₁, P₂, P₃) and a private (secret) key, sk=(P⁻¹, S⁻¹, G, Q).

For ease of explanation, digital signing process 200 is described with respect to one keypair; however, the person of ordinary skill in the art will understand that the principles described herein are applicable to the case where multiple keypairs are generated and utilized.

In exemplary operation, digital signing process 200 may begin at optional step 202. In step 202, the signer (e.g., sender device 102, FIG. 1, and/or a processor thereof, such as sender processor 114) uses the certificate, cert, to create a hash of the document/certificate. In this example, the hash certificate is denoted as h(cert), but may also be more generally denoted as h(doc). In an exemplary embodiment of optional step 202, the relevant hash function is expected to be trusted and secure, and also should return an s-bit hash, where s has a value of at least 256 or 512. In an exemplary embodiment, the particular hash function has been agreed upon in advance between the parties (e.g., CA, sender, receiver), since the same hash function is utilized for verification as well.

In optional step 204, the signer uses an agreed-upon pseudorandom number generator (described above), as well as a specific seed, denoted seed, to generate a random n-bit value. In an exemplary embodiment of optional step 204, the signer converts this random n-bit value into a vector, namely, random vector r. As described above, step 204 may be optional in the case where it may be more desirable to process and communicate the seed instead of the random vector, or in the case where the particular PKI implementation may choose to transmit the entire random vector r instead of the seed. As an illustrative example, digital signing process 102 is described as utilizing seed, as opposed to the random vector r, for optimization purposes.

In step 206, the signer concatenates the hashed certificate h(cert) with the first n−s bits of the random vector r according to the equation:

$$h = [ h ( cert ) \vert {r}_{n - s} ] , \qquad ( Eq . 30 )$$

where h is also an n-bit vector, but having its first s bits obtained from the hash certificate h(cert), and its last n−s bits obtained from the derived random vector r. In an exemplary embodiment of step 206, it is presumed that, since the signer has access to pk, sk, and cert/doc, the signer will also be able to obtain h(cert) or h(doc), and thus calculate h=[h(cert)|rₙ₋ₛ] or h=[h(doc)|rₙ₋ₛ].

The person of ordinary skill in the art will understand that the concatenation technique of step 206 is not contemplated by the conventional MGD scheme, which instead simply hashes the subject document twice. Accordingly, the concatenation operation of step 206 enables the use of significantly longer codewords than the conventional MGD scheme, and without sacrificing the entropy created within the hash function from the pseudorandom number generator. Accordingly, digital signing process 200 represents a significant improvement over prior art techniques.

In step 208, the signer may compute a syndrome s according to the equation:

$$s = h Q . \qquad ( Eq . 31 )$$

In step 210, the signer may, using the elements from Eq. 31, further calculate a ciphertext/codeword c according to the equation:

$$c = h + {s p}_{2} . \qquad ( Eq . 32 )$$

In an exemplary embodiment, the calculation of step 210 may be considered, at a high level, to essentially “fix” the errors in the n-bit vector h to construct the codeword c.

In step 212, the signer may execute an appropriate Goppa code decoding algorithm to decode cP⁻¹ (e.g., the codeword c by the inverse permutation matrix P⁻¹) to yield, from the decoded codeword, the element denoted herein as sig. It may be noted here that the calculation of step 212 further illustrates how the signature functionality according to digital signing process 200 improves over the analogous step of the conventional MGD scheme (e.g., Eq. 16, above). Whereas the conventional MGD scheme is limited to its double-hash of the subject document, systems and methods according to digital signing process 200 are capable of achieving significantly greater levels of security through use of the random vector r, which may advantageously result in the use of much longer and/or flexible codewords and signatures than could be achieved according to the prior art techniques.

In step 214, the signer may further calculate the value for d according to the following equation:

$$d = r Q + s . \qquad ( Eq . 33 )$$

In step 216, the signer may further calculate the digital signature σ for the certificate cert such that the full signature conforms to:

$$σ = ( sig , r , d ) . \qquad ( Eq . 34 )$$

In an exemplary embodiment of step 216, it may be seen, from Eq. 34, that the random vector r becomes part of the signature σ. Nevertheless, as discussed above, the random vector r may be alternatively sent with the signature σ if the random vector r is not already apart of the public key pk. For example, in an alternative embodiment of step 216, instead of the entire random vector r, seed may be used and sent as part of the signature a according to:

$$σ = ( sig , seed , d ) . \qquad ( Eq . 35 )$$

According to this alternative embodiment, the verifier (e.g., receiver device 104, FIG. 1) is advantageously enabled to independently generate the random vector r from the agreed-upon pseudorandom generator, thereby avoiding the possibility of having to send the random vector r over an insecure channel. Moreover, because seed will contain significantly fewer bits than the random n-bit vector r, the relative size of the resulting signature σ may be optimized with significantly greater flexibility, and without sacrificing security for the conventional trade-off between greater security and the sacrifice to greater computing resources.

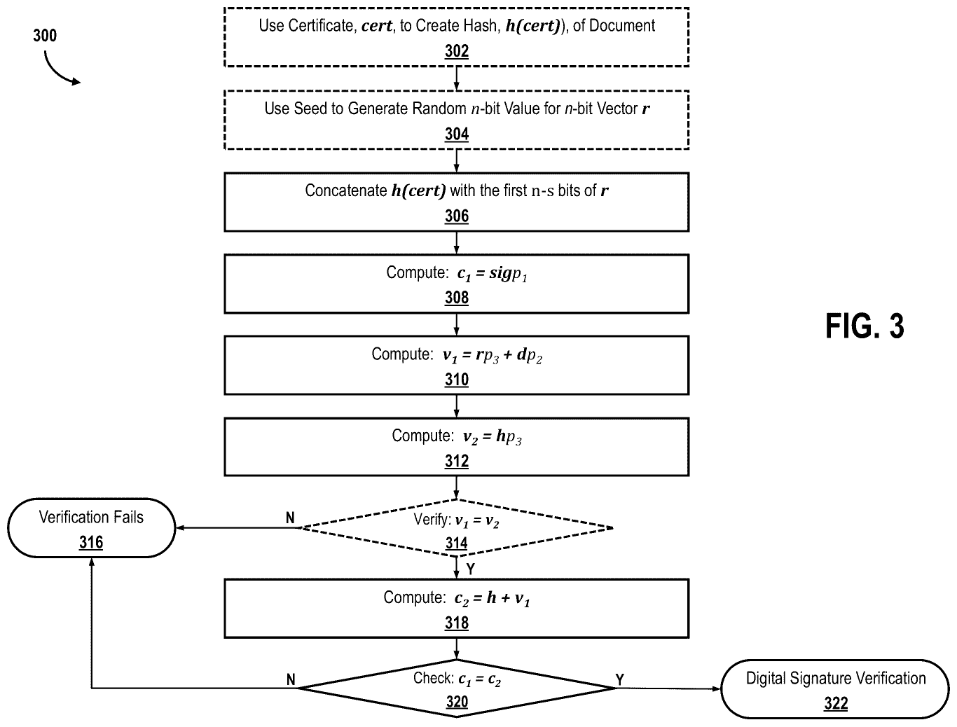

In step 218, digital signing process 200 is completed with the production of a digitally signed certificate (e.g., from step 216), which then may be sent to the verifier (e.g., receiver device 104, FIG. 1) over a respective communication channel (e.g., communication medium 106, FIG. 1). Verification processing by the verifier is described further below with respect to FIG. 3.

### Verification Algorithm

FIG. 3 is a flow diagram depicting an exemplary digital verification process 300 for receiver device 104 and/or decryption module 116, FIG. 1. In an exemplary embodiment, digital verification process 300 may also be executed in cooperation with CA 124, FIG. 1, as well as with one or more of the processing steps described above with respect to the key generation functional portion of the present enhanced signature scheme.

In some embodiments, several steps or substeps of digital verification process 300 may also be optional, and/or may be optionally executed separately from digital verification process 300, for example, as preliminary steps thereof, similar to digital signing process 200, FIG. 2, described above. Furthermore, unless described otherwise to the contrary, some steps of process digital verification process 300 may be performed in a different order than that described below, and/or one or more steps of digital verification process 300 may be performed simultaneously. Additionally, digital verification process 300 may include more or fewer steps without departing from the scope herein.

With respect to the following detailed description of digital verification process 300, it is assumed that the verifier (e.g., receiver device 104, FIG. 1) will also have access to the subject document cert (or doc), the public key pk=(p₁, p₂, P₃), and the signature from the sender, σ=(sig, seed, d) (or (sig, r, d)). In the exemplary embodiment depicted in FIG. 3, digital verification process 300 is also described with respect to the PKI paradigm, but is not limited exclusively thereto. For ease of explanation, similar to the exemplary description of digital signing process 200, FIG. 2, digital verification process 300 is also described, for illustrative purposes, with respect to one keypair.

In exemplary operation, digital verification process 300 may begin with optional steps 302 and 304, which are analogous to optional steps 202 and 204, respectively, of digital signing process 200, FIG. 2. For example, in optional step 302, the verifier (e.g., receiver device 104, FIG. 1, and/or a processor thereof, such as receiver processor 122) may also use cert to create a hash of the document/certificate, again denoted as h(cert). That is, the hash function used for verification should be the same hash function used for digital signing or in the corresponding signature algorithm. Similarly, in optional step 304, the verifier may also use the agreed-upon pseudorandom number generator and the seed to generate a random n-bit value such that the verifier is enabled to independently derive the random n-bit vector r. As described above, it may be more desirable, for optimization purposes, to process the seed instead of the random vector r. In some embodiments, the verifier may have already received the random vector r from the sender or associated CA.

In step 306, the verifier, similar to step 206 of digital signing process 200, FIG. 2, concatenates the hashed certificate h(cert) with the first n−s bits of the random vector r according to the equation:

$$h = [ h ( cert ) \vert {r}_{n - s} ] , \qquad ( Eq . 36 )$$

which substantively similar to Eq. 30, above. That is, h is again an n-bit vector having its first s bits obtained from the hash certificate h(cert), and its last n−s bits obtained from the derived random vector r. In an exemplary embodiment of step 306, it is presumed that, since the verifier has access to pk, σ, and cert/doc, the verifier will also be able to obtain h(cert) or h(doc), and thus be enabled to calculate h=[h(cert)|rₙ₋ₛ] or, h=[h(doc)|rₙ₋ₛ].

In step 308, the verifier may further calculate a first verification ciphertext/codeword c₁ according to the equation:

$${c}_{1} = {sig p}_{1} . \qquad ( Eq . 37 )$$

It may be noted that the calculation of c₁ is similar to the calculation of a in the conventional MGD scheme (e.g., Eq. 17, above).

In step 310, the verifier may further calculate a first verification vector v₁ according to the equation:

$${ν}_{1} = {r p}_{3} + {d p}_{2} . \qquad ( Eq . 38 )$$

It may be noted here that, if the vector v₁ is untampered, then v₁=sp₂. It may be further noted that the calculation of step 310 further illustrates how the verification functionality according to digital verification process 300 improves over the analogous step of the conventional MGD scheme (e.g., Eq. 18, above) by using the random vector r to calculate the vector v₁ instead of the double-hash of the subject document used by the conventional MGD scheme.

In step 312, the verifier may further calculate a second verification vector v₂ according to the equation:

$${ν}_{2} = {hp}_{3} . \qquad ( Eq . 39 )$$

Step 314 is an optional decision step. In step 314, digital verification process 300 determines whether the first verification vector v₁ (i.e., from Eq. 38) is equal to the second verification vector v₂ (i.e., from Eq. 39), or more simply, that v₁=v₂. In an exemplary embodiment of step 314, digital verification process 300 checks the first and second verification vectors v₁, v₂ to determine whether a correct error value has been created and/or the correct private keys were used, thereby adding integrity to the subject document (e.g., not forged). In some embodiments, decision step 314 may be deemed optional for optimization purposes.

If, in step 314, digital verification process 300 determines that the first and second verification vectors v₁, v₂ are not equal, then digital verification process 300 proceeds to step 316, in which it has been determined that the verification has failed, upon which digital verification process 300 terminates. If, however, in step 314, digital verification process 300 determines that the first and second verification vectors v₁, v₂ are equal, digital verification process 300 proceeds to step 318.

In step 318, the verifier may, using the elements from Eq. 39, further calculate a second verification ciphertext/codeword c₂ according to the equation:

$${c}_{2} = h + {ν}_{1} . \qquad ( Eq . 40 )$$

It may be noted that the calculation of c₂ is similar to the calculation of c in the conventional MGD scheme (e.g., Eq. 20, above).

Step 320 is a decision step. In step 320, digital verification process 300 determines whether the first verification codeword c₁ (i.e., from Eq. 37) is equal to the second verification codeword c₂ (i.e., from Eq. 40), or more simply, that c₁=c₂. In an exemplary embodiment of step 314, digital verification process 300 checks the first and second verification codewords c₁, c₂ to determine whether a correct codeword has been created, thereby adding further integrity that the signature a was not forged and/or that the subject document cert (or doc) has not been tampered with.

If, in step 320, digital verification process 300 determines that the first and second verification codewords c₁, c₂ are not equal, then digital verification process 300 proceeds to step 316, indicating that the verification is failed. If, however, in step 320, digital verification process 300 determines that the first and second verification codewords c₁, c₂ are equal, digital verification process 300 proceeds to step 322, in which the digital signature a (e.g., from the signer of digital signing process 200, FIG. 2) is deemed to be successfully verified.

Similar to the embodiments described above with respect to digital signing process 200, FIG. 2, the verifier of digital verification process 300 is also advantageously enabled to, where desired, independently derive the random n-bit vector r from the seed, thereby greatly improving that only the computational speed and efficiency of the present enhanced digital signature scheme, but also the memory capabilities of the respective sender and receiver devices thereof, as well as that of certificates provided from a CA.

For example, as described above, the respective devices that utilize the present enhanced digital signature scheme are enabled to have to store only the small amount of memory required for the seed, instead of the significantly larger signatures or random bit vectors that are required for the ever-increasing security needs of the PKI paradigm. Systems and methods according to the present enhanced digital signature scheme may therefore advantageously avoid the conventional trade-off that sacrifices computing resources and processing speed for increased security of larger signatures that are transferred between devices, particularly as the size of the relevant public and private keys (e.g., handled by a root CA) continue to increase. That is, the memory resources saved from use of the seed may free up considerably more memory space on a given certificate for significantly larger public and private keys.

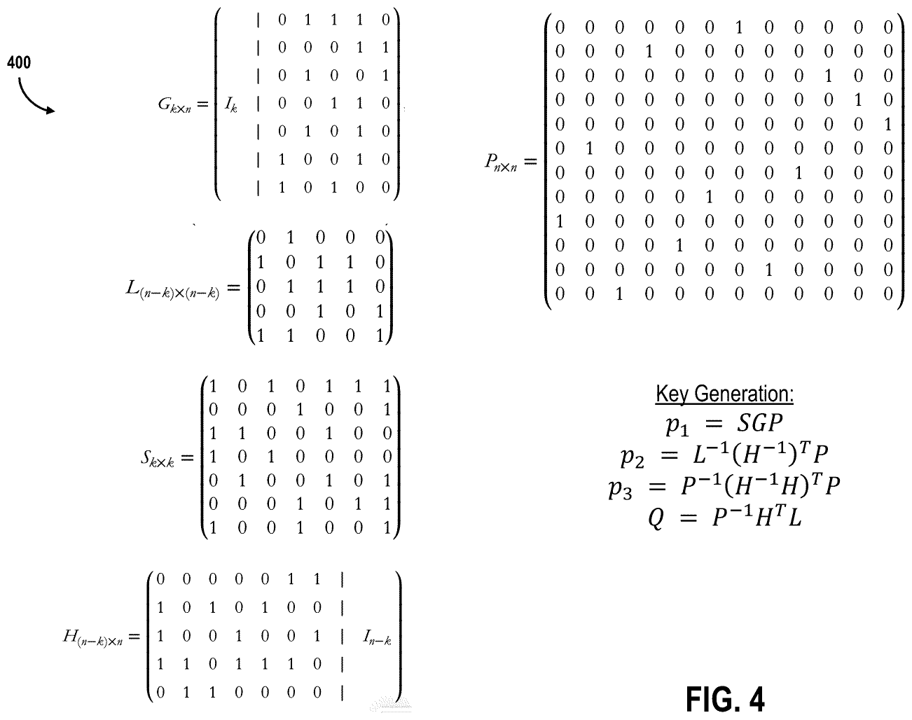

FIG. 4 is a graphical illustration depicting exemplary matrices 400 generated according to the embodiments herein. In the exemplary embodiment depicted in FIG. 4, the person of ordinary skill in the art will understand that the several matrices 400 are provided, by way of illustration, for a significantly simplified case scenario, i.e., relatively small parameters that may be used for several of the matrices listed in TABLE 1, above, as well as for the systems and methods described herein.

For example, according to the simplified case scenario depicted in FIG. 4, using an exemplary matrices 400, h(doc)=[10001], r=[101001010100], h=[h(doc)rₙ₋ₛ]=[100011010010], s=hQ=[11110], c=h+sp₂=[111100001011], sig=[0000110], d=[10011], c₁=sigp₁=[111100001011], v₁=rp₃+dp₂=[011111011001], and v₂=hp₃=[011111011001]. Thus, the computational complexity is already considerable when using relatively small parameter values for n, t, and k, to which the conventional signature schemes are limited.

According to the present systems and methods though, significantly larger parameter values may be used longer-term without sacrificing the security needs of the PKI paradigm, as would result from attempted implementation of the conventional signature schemes described above. For example, utilizing one or both of digital signing process 200, FIG. 2, and digital verification process 300, FIG. 3, an exemplary case scenario uses the following parameter values: n=6688; t=128; and k=5024 (e.g., based on the particular Goppa code chosen). According to this exemplary case scenario, the resulting size of the signature σ will be 1,672 bytes, whereas the corresponding size of the public key pk may be as large as 11,182,336 bytes, and the private key sk as large as 14,337,408 bytes. The conventional schemes described above, on the other hand, would require significantly larger signature sizes commensurate with a respective sizes of the public and private keys.

Accordingly, the present embodiments provide an enhanced digital signature scheme that leverages the balanced approach and security features seen in the conventional McEliece cryptosystem and MGD scheme, but advantageously overcomes the known challenges to these conventional techniques that has prevented their implementation with respect to hire-security paradigms, such as a PKI. The present systems and methods are therefore of particular value with respect to signature and verification functional requirements of a root CA. In an exemplary embodiment, the present systems and methods implement one or more algorithms to ensure that a certificate is signed by the private key in such a way that the certificate may be verified by the public key.

The computer-implemented methods and processes described herein may include additional, fewer, or alternate steps and or functionality, including such as discussed above herein. The present systems and methods may be implemented using one or more local or remote processors, transceivers, and/or sensors (such as processors, transceivers, and/or sensors mounted on vehicles, stations, nodes, or mobile devices, or associated with smart infrastructures and/or remote servers), and/or through implementation of computer-executable instructions stored on non-transitory computer-readable media or medium. Unless described herein to the contrary, the various steps of the several processes may be performed in a different order, or simultaneously in some instances.

Additionally, the computer-implemented systems, methods, and apparatuses described herein may include additional, fewer, or alternative elements and respective functionalities, including those discussed elsewhere herein, which themselves may include or be implemented according to computer-executable instructions stored on non-transitory computer-readable media or medium.

In the exemplary embodiment, a processing element may be instructed to execute one or more of the processes and subprocesses described above by providing the processing element with computer-executable instructions to perform such steps/substeps, and store collected data (e.g., time variant parameters, digital signatures, certificates, etc.) in a memory or storage associated therewith. This stored information may be used by the respective processing elements to make the determinations necessary to perform other relevant processing steps, as described above.

The aspects described herein may be implemented as part of one or more computer components, such as a client device, system, and/or components thereof, for example. Furthermore, one or more of the aspects described herein may be implemented as part of a computer network architecture and/or a cognitive computing architecture that facilitates communications between various other devices and/or components. Thus, the aspects described herein address and solve issues of a technical nature that are necessarily rooted in computer technology.

Furthermore, the embodiments described herein improve upon existing technologies, and improve the functionality of computers, by more reliably protecting the security of communications and/or certificates exchanged within a PKI paradigm. The present embodiments therefore improve the speed, efficiency, and reliability in which such determinations and processor analyses may be performed, while simultaneously reducing the computational resources required to process ever-increasing the length and breadth of PKI-related digital signatures. Due to these improvements, the aspects described herein address computer-related issues that significantly improve the security of PKI-based communications and certificates in comparison with conventional techniques. Thus, the aspects herein may be seen to also address computer-related issues such as communication security between electronic computing devices or systems, for example.

Exemplary embodiments of systems and methods for enhanced digital signature schemes are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system for processing digital signatures, comprising:
a sender device configured to (a) encrypt an original plaintext message into an encrypted ciphertext message, and (b) transmit the encrypted ciphertext message over a communication medium in operable communication with the sender device; and
a receiver device (a) in operable communication with the communication medium, and (b) configured to (i) receive the encrypted ciphertext message from the communication medium, (ii) decrypt the encrypted ciphertext message into a coded plaintext message, (iii) decode the coded plaintext message into a readable plaintext message, and (iv) output the readable plaintext message to the receiver device such that the readable plaintext message substantially corresponds to the original plaintext message at the sender device,
wherein each of the sender device and receiver device are in operable communication with a certificate authority (CA) of a public key infrastructure (PKI) configured to generate at least one keypair including a public key and a private key, and
wherein the sender device is further configured to encrypt the original plaintext message, and the receiver device is further configured to decrypt the encrypted ciphertext message, using a coding scheme (a) common to both of the sender and receiver devices, and (b) configured for at least one document containing at least the public key.

2. The system of claim 1, wherein the sender device comprises an encryption module configured to encrypt the original plaintext message into the encrypted ciphertext message.

3. The system of claim 2, wherein the encryption module is disposed remotely from the sender device, between the sender device and the communication medium.

4. The system of claim 2, wherein the encryption module is integrated within the sender device.

5. The system of claim 2, wherein the encryption module comprises a processor and a memory configured to store computer-executable instructions therein, which, when executed by the processor, cause the sender device to execute a signature algorithm configured to sign the document using the coding scheme.

6. The system of claim 1, wherein the coding scheme includes at least one hash function from a pseudorandom number generator, and wherein each of the sender device and the receiver device are further configured to access to the pseudorandom number generator.

7. The system of claim 1, wherein the document is a PKI certificate, and wherein the coding scheme includes at least one random vector that is (a) unique to the PKI certificate signed, and (b) accessible by both the sender device and the receiver device.

8. The system of claim 7, wherein each of the sender device and the receiver device are further configured to (a) obtain a seed from a common pseudorandom number generator, and (b) independently derive the random vector from the seed.

9. The system of claim 7, wherein a first bit size of the seed is significantly smaller than a second bit size of the random vector.

10. The system of claim 1, wherein the coding scheme includes a codeword based on a specific Goppa code.

11. The system of claim 10, wherein the coding scheme further includes one or more matrices configured to generate and/or verify the codeword.

12. The system of claim 11, wherein the one or more matrices include one or more of a generator matrix, a parity check matrix, an invertible matrix, a permutation matrix, an inverse parity check matrix, and an inverse permutation matrix.

13. The system of claim 10, wherein the codeword has a codeword length of at least 3488 bits.

14. The system of claim 1, wherein the receiver device comprises a decryption module configured to decrypt the encrypted ciphertext message into the coded plaintext message and decode the coded plaintext message into the readable plaintext message.

15. The system of claim 14, wherein the decryption module comprises a processor and a memory configured to store computer-executable instructions therein, which, when executed by the processor, cause the receiver device to execute a verification algorithm configured to verify a signature, received from the sender device, for the document.

16. An apparatus for signing a digital certificate from a Certificate Authority (CA) of a Public Key Infrastructure (PKI), the apparatus comprising:
a processor; and
a memory device in operable communication with the processor and configured to store computer-executable instructions therein, which, when executed by the processor, cause the apparatus to:
obtain a PKI certificate from the CA;
concatenate a hash of the PKI certificate with a first number of bits of a random n-bit vector, wherein n is an integer greater than 2;
compute a syndrome for the concatenated hash of the PKI certificate;
calculate a codeword based on the computed syndrome, a public key of the PKI certificate, and the concatenated hash of the PKI certificate;
decode the codeword to obtain a signature element therefrom; and
output a digital signature for the PKI certificate based on the signature element, the random n-bit vector, and the computed syndrome.

17. The apparatus of claim 16, wherein the instructions further cause the apparatus to generate the random n-bit vector from a seed obtained from a pseudorandom number generator, wherein the seed has a bit size substantially less than n.

18. An apparatus for verifying a signature for a Public Key Infrastructure (PKI) certificate, the apparatus comprising:
a processor; and
a memory device in operable communication with the processor and configured to store computer-executable instructions therein, which, when executed by the processor, cause the apparatus to:
obtain a signature of the PKI certificate;
concatenate a hash of the PKI certificate with a first number of bits of a random n-bit vector, wherein n is an integer greater than 2;
calculate a first codeword based on a signature element of the obtained signature and a public key of the PKI certificate;
compute (a) a first verification vector based on the random n-bit vector and the public key of the PKI certificate, and (b) a second verification vector based on the concatenated hash of the PKI certificate;
calculate a second codeword based on the first verification vector and the concatenated hash of the PKI certificate;
compare the first codeword with the second codeword; and
verify, based on the comparison of the first codeword with the second codeword, the obtained signature for the PKI certificate.

19. The apparatus of claim 18, wherein the instructions further cause the apparatus to generate the random n-bit vector from a seed obtained from a pseudorandom number generator, wherein the seed has a bit size substantially less than n.

20. The apparatus of claim 18, wherein the instructions further cause the apparatus to, prior to the comparison of the first codeword with the second codeword, check that the first verification vector is equal to the second verification vector.
